(19) United States
(12) Patent Application Publication
(10) Pub. No.: US 2021/0381520 A1
(43) Pub. Date: Dec. 9, 2021

(54) COOLANT PLUG-IN PUMP WITH SEALING WASHER TO MINIMIZE THE SEALING GAP

(71) Applicant: NIDEC GPM GmbH, Auengrund OT Merbelsrod (DE)

(72) Inventor: Franz PAWELLEK, Lautertal (DE)

(21) Appl. No.: 17/286,036

(22) PCT Filed: Sep. 10, 2019
(86) PCT No.: PCT/EP2019/074084

§ 371 Date: Apr. 16, 2021

(30) Foreign Application Priority Data
Oct. 18, 2018 (DE) 10 2018 125 904.2

(51) Int. Cl. F04D 29/12; F04D 29/42; F04D 29/62; F01P 5/12

(52) U.S. Cl. CPC F04D 29/126; F04D 29/426; F01P 2005/125; F01P 5/12; F04D 29/628

(57) ABSTRACT

A plug-in coolant pump for motor vehicles includes an impeller surrounded by a pump housing. The impeller can be driven about a longitudinal axis extending through the pump housing by a pump shaft. A seal is provided between the pump shaft and the pump housing to seal the coolant-carrying pump housing, wherein the pump housing includes retaining domes on which a sealing disc is fastened which sets a sealing gap between a pump inlet with a pressure slope and the open impeller.

### CROSS REFERENCE TO RELATED APPLICATIONS

This is a U.S. national stage of PCT Application No. PCT/EP2019/074084, filed on Sep. 10, 2019, with priority under 35 U.S.C. § 119(a) and 35 U.S.C. § 365(b) being claimed from European Patent Application No. 102018125904.2, filed Oct. 18, 2018, the entire disclosures of each of which being hereby incorporated herein by reference.

### 1. FIELD OF THE INVENTION

The present invention relates to a plug-in coolant pump for motor vehicles.

### 2. BACKGROUND

In water-cooled internal combustion engines, coolant pumps designed as centrifugal pumps are generally used, the bearing shafts of which are driven directly by the engine crankshaft, for example by way of a belt drive. Such coolant pumps are known to be designed as plug-in pumps without their own volute housing. In this case, the sealing gap on the impeller, which is essential for volumetric efficiency, is defined by a corresponding mating contour on the motor. Closed impellers with cover disks are used. The addition of the manufacturing tolerances of pump and mating contour usually results in large sealing gap heights, which lead to a considerable reduction in volumetric efficiency.

### SUMMARY

Example embodiments of the present disclosure provide plug-in coolant pumps for motor vehicles that each achieve good volumetric efficiency regardless of manufacturing tolerances.

An example embodiment of a plug-in coolant pump for motor vehicles including an impeller surrounded by a pump housing, includes a pump shaft to drive the impeller about a longitudinal axis, the pump shaft passing through the pump housing, and a seal to seal the coolant-carrying pump housing between the pump shaft and the pump housing, and the pump housing including retaining domes on which a sealing disc is fastened which sets a sealing gap between a pump inlet with a pressure slope and the open impeller. The sealing gap can be adjusted on the pump side by using the sealing disc and is thus independent of the manufacturing tolerances of the motor block. The impeller can be open because a sealing washer is used. An open impeller is more cost-effective.

Preferably, the sealing washer is positioned concentrically relative to the pump shaft and is a sealing ring.

It is preferred that the sealing disc is curved inward away from the impeller in the radial direction and has a shape corresponding to the shape of the impeller.

Preferably, an electric motor is provided to drive the pump shaft.

In an example embodiment, the sealing disc is attached to the retaining domes by retaining pins. Preferably, at least three retaining domes are provided, which are evenly distributed in the circumferential direction to the longitudinal axis.

It is advantageous if the retaining domes terminate with an edge of the pump housing in the longitudinal direction and thus do not protrude.

In an advantageous example embodiment, the sealing washer includes a sealing lip.

The plug-in coolant pump described above is intended for installation in a mounting bore of an engine block of an internal combustion engine of a motor vehicle.

Furthermore, an internal combustion engine of a motor vehicle is provided with an engine block including a mounting bore and with a plug-in coolant pump described above, which is attached to the engine block, wherein the sealing lip seals a gap located between the sealing washer and the engine block. Preferably, the engine block includes a pump inlet. The motor block may also include a volute housing. Preferably, the pump housing is located completely outside the motor block.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 shows a longitudinal section through a coolant pump 1 along a pump shaft 2 according to an example embodiment of the present invention.

### DETAILED DESCRIPTION

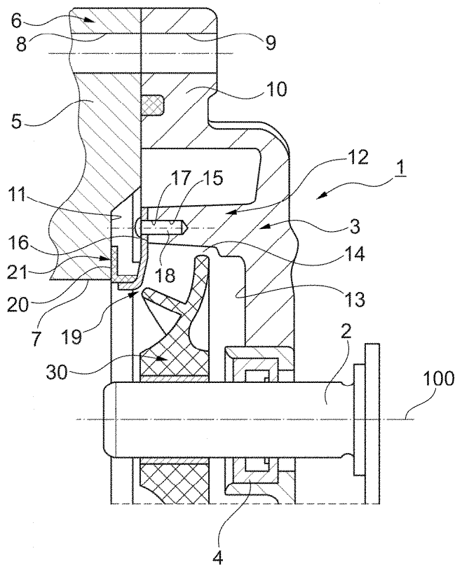

An example embodiment of the disclosure is explained in more detail below with reference to FIG. 1. An impeller 30 is arranged in a rotationally fixed manner on the pump shaft 2 and is surrounded by a pump housing 3. The pump shaft 2 passes through the pump housing 3. A lip seal 4 is arranged between the pump shaft 2 and the pump housing 3 to seal the coolant-carrying pump housing 3. The pump shaft 2 is preferably driven to rotate about a longitudinal axis 100 by way of an electric motor which is not shown and which is preferably designed as a dry rotor. The coolant pump 1 is designed as a plug-in pump, i.e. the pump housing 3 is connected to an engine block 5 of an internal combustion engine of a motor vehicle via interfaces 6. An inlet of the pump 7 and a spiral duct not shown are located in the engine block 5. The interfaces 6 conventionally have corresponding bores 8,9 through which the engine block 5 and the pump housing 3 are screwed together. The pump housing 3 is substantially cup-shaped and has a rim 10 on which the interfaces 6 are arranged. The pump shaft 2 projects beyond the edge of the pump housing 10 in the longitudinal direction 100. The motor block 5 has a mounting bore 11 in the inlet 7. An end of the pump shaft 2 close to the impeller projects longitudinally into the mounting bore 11. The impeller 30 itself lies completely outside the motor block 5.

Retaining domes 12 are provided, which are part of the pump housing 3 and project from a bottom of the pump housing 13, on the side near the impeller and extend parallel to the longitudinal axis 100. The retaining domes 12 are evenly distributed in the circumferential direction around the longitudinal axis 100. Preferably, at least three retaining domes 12 are provided. The retaining domes 12 are thereby arranged in close proximity to the impeller 30 along the radius. An annular gap 14 is provided between the envelope of the impeller and the envelope of the retaining domes, so that the impeller 30 can rotate without obstruction. The end faces of the retaining domes 12 are approximately flush with the edge of the pump housing 10. The retaining domes 12 are approximately cylindrical in shape and have a central bore 15 extending along the longitudinal axis of the domes. A sealing washer 16 rests on the end faces of the retaining domes 12 and also has bores 17 corresponding to those of the retaining domes, do that retaining pins 18 can be used to firmly secure the sealing washer 16 to the domes 12. The sealing disc 16 has an outer radius and an inner radius, the outer radius being dimensioned such that the disc rests on the domes 12 over their entire surface but does not project beyond them to any great extent. The width of the sealing disc is defined as the difference between the outer radius and the inner radius. The height of the sealing disc is the extension of the sealing disc parallel to the longitudinal axis 100. The width of the sealing disc is significantly greater than the height. The width is in a range between 10% to 30% of the outer radius, preferably in a range between 1 mm and 3 mm. The sealing disc 16 is curved inwards towards the longitudinal axis 100, in the direction of the engine block 5. In the radial direction, the sealing disk 16 lies within the mounting bore 11. In the radial direction, it does not project inward toward the center beyond the mounting bore 11 or the inlet 7. In the axial direction, the sealing disk 16 projects radially inward into the mounting bore 11, so that the sealing disk 16 forms a transition area to the suction chamber located in the engine block 5. The sealing disk 16 is arranged concentrically to the longitudinal axis 100. It is rotationally symmetrical. The shape of the sealing disk 16 is adapted to the shape of the open impeller 30, so that a sealing gap 19 located between the impeller 30 and the sealing disk 16 can be set to a minimum dimension. Since the sealing gap 19 is defined by the position and design of the sealing disk 16 and the impeller 30, the size of the sealing gap 19 that forms is independent of the manufacturing tolerances of the mounting bore 11 of the engine block. A gap 20 can form between the sealing disk 16 and the mounting bore 11 of the engine block, which is sealed by a sealing lip 21. The sealing lip 21 is attached to the sealing disc 16 and is curved from the sealing disc 16 in a radial direction from the inside to the outside, so that it rests against the mounting bore 11 perpendicular to the longitudinal axis 100. The sealing disc preferably has a collar onto which the lip seal is pressed or vulcanized. Particularly preferably, the sealing lip 21, viewed in the radial direction, is pressed or vulcanized onto the collar from the outside. The sealing lip 21 is flexible and seals the gap 20 between the sealing washer 16 and the engine block 5 due to the pressure gradient between the pump pressure and the inlet pressure. Preferably, the sealing washer is made of steel.

In the operating state of the coolant pump 1, the coolant flows axially via the inlet 7 located in the engine block 5 to the impeller 30 and is directed radially via the vanes into a channel not shown. Sealing via the sealing disc 16 prevents backflow.

The use of sealing disk 16 also allows the use of open impellers, which are significantly less expensive to manufacture because there is no need for an additional cover disk. The efficiency of the plug-in pump can be significantly increased so that a separate electric motor can be used as the drive instead of a belt drive.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-12. (canceled)

13: A plug-in coolant pump of a motor vehicle, the plug-in coolant pump comprising:
an open impeller surrounded by a pump housing and drivable about a longitudinal axis by a pump shaft extending through the pump housing; and
a seal between the pump shaft and the pump housing to seal the pump housing; wherein
the pump housing includes retaining domes on which a sealing disc is fastened to set a sealing gap between a pump inlet with a pressure slope and the open impeller.

14: The plug-in coolant pump according to claim 13, wherein the sealing disc is positioned concentrically to the pump shaft and is defined by a sealing ring.

15: The plug-in coolant pump according to claim 13, wherein the sealing disc is curved inwardly away from the impeller in the radial direction and has a shape corresponding to a shape of the impeller.

16: The plug-in coolant pump according to claim 13, wherein an electric motor to drive the pump shaft is provided.

17: The plug-in coolant pump according to claim 13, wherein the sealing disc is fixed to the retaining domes by retaining pin.

18: The plug-in coolant pump according to claim 13, wherein at least three of the retaining domes are provided, the retaining domes being uniformly distributed in a circumferential direction with respect to the longitudinal axis.

19: The plug-in coolant pump according to claim 13, wherein the retaining domes terminate at an edge of the pump housing in the longitudinal direction.

20: The plug-in coolant pump according to claim 13, wherein the sealing disk includes a sealing lip.

21: The plug-in coolant pump according to claim 13, wherein the plug-in coolant pump is installed in a mounting bore of an engine block of an internal combustion engine of a motor vehicle.

22: An internal combustion engine of a motor vehicle, the internal combustion engine comprising:
an engine block including a mounting bore; and
the plug-in coolant pump according to claim 13; wherein
the plug-in coolant pump is fastened to the engine block; and
a sealing lip of the sealing disc seals a gap located between the sealing disc and the engine block.

23: The internal combustion engine according to claim 22, wherein the engine block includes a pump inlet.

24: The internal combustion engine according to claim 22, wherein an entirety of the pump housing is outside the engine block.
